(19) United States
(12) Patent Application Publication
(10) Pub. No.: US 2012/0100393 A1
(43) Pub. Date: Apr. 26, 2012

(54) METHOD FOR PRODUCING DECORATIVE METALLIC ARTICLE HAVING WOODGRAIN METAL PATTERN, AND DECORATIVE METALLIC ARTICLE HAVING WOODGRAIN METAL PATTERN

(75) Inventors: Masashi Hirama, Tokyo (JP); Hidekazu Yoshihara, Tokyo (JP); Ryota Mitsuhashi, Tokyo (JP); Tomoaki Kasukawa, Tokyo (JP); Akiyoshi Yatsugi, Tokyo (JP)

(73) Assignee: Aida Chemical Industries Co., Ltd., Tokyo (JP)

(21) Appl. No.: 13/381,806

(22) PCT Filed: Aug. 19, 2010
(86) PCT No.: PCT/JP2010/064027

§ 371 Date: Dec. 30, 2011

(30) Foreign Application Priority Data
Aug. 19, 2009 (JP) 2009-190373
Sep. 27, 2009 (JP) 2008-221733
Sep. 27, 2009 (JP) 2009-221735
Sep. 30, 2009 (JP) 2009-227961
Sep. 30, 2009 (JP) 2009-227962
Sep. 30, 2009 (JP) 2009-227963

(51) Int. Cl. B32B 15/00; C04B 37/02

(52) U.S. Cl. 428/687; 156/89.28

(57) ABSTRACT

Provided are a method for producing a decorative metallic article having a wood grain metal pattern and the decorative metallic article having the wood grain metal pattern; the decorative metallic article comprising a sintered copper part produced by sintering a plastic copper containing clay compound, and a sintered silver part produced by sintering a plastic silver containing clay compound. The method comprises: a plate forming step of forming the plastic copper containing clay compound and the plastic silver containing clay compound into plate-like shapes respectively, so as to produce a copperplate and a silver plate; a multi layering and adhesion step of mutually laminating the copper and silver plates one another, and elongating the plates so that a thickness of the laminated plates decreases in 10% or more, thereby to adhesively paste the laminated plates together; a decorative object forming step of forming a multi layered decorative copper-silver object by using the multi layered plate; a multi layered decorative copper-silver object drying step of drying the multi layered decorative copper-silver object; a wood grain metal pattern forming step of cutting or polishing a surface of the dried multi layered decorative copper-silver object to form notches so that the wood grain metal pattern appears on the decorative object; and the sinter producing step of sintering the decorative object on which the notches are formed, thereby to obtain the decorative metallic article (69).

### FIELD OF THE INVENTION

The present invention relates to a method for producing a decorative metallic article having a wood grain metal pattern and the decorative metallic article having the wood grain metal pattern, used in jewelry goods, ornaments, and clothing accessories or the like; the decorative metallic article comprised of a sintered copper part produced by sintering a plastic copper containing clay-like compound including at least one kind of a powder metal selected from copper or a copper alloy, and a sintered silver part produced by sintering a plastic silver containing compound including at least one kind of a powder metal selected from silver or a silver alloy.

### BACKGROUND OF THE INVENTION

As a technique of Japanese unique metalworking originated in the Japanese historical Edo period about 400 years ago, a wood grain metal (or “mokumegane”) technique has been known. The wood grain metal technique comprises the steps of: diffusion-joining plates by laminating a plurality of ground metals such as copper, silver and gold having different color tones to form one sheet of a ground metal; creating a wood grain metal pattern by beating and scraping a part of the surface of the resulting ground metal by a chisel; and repeatedly performing processes to make protrusions of the surface of the ground metal flat using a hammer, thereby to form a unique pattern. Further, it is possible to color the resultant plate of the ground metal by boiling in a verdigris solution. Originally, the above mentioned wood grain metal technique (or mokumegane) mainly spread as a technique of a decorative art for decorating a samurai sword (or handguard of the sword). Today, the wood grain metal technique has been performed in countries all over the world including the USA besides Japan, yielding manufacturers of the wood grain metal pattern, such as metal craftsmen and jewelry artists. However, absolutely, it is hard to say that the wood grain metal technique itself is sufficiently known or spreads worldwide.

Here, a technique of forming a pattern by laminating a plurality of metallic plates having different color tones includes a procedure to prevent the entering of oxygen (or air), in order to suppress oxidation of the metallic plates when the diffusion-joining is performed. For that purpose, the procedure comprises the steps of applying a mixture of charcoal and filling powder to peripheries of the laminated metallic plates, and heating the resultant plates.

Alternatively, several other procedures have been proposed, instead of the method for applying a mixture of charcoal and filling powder to the peripheries of the laminated metallic plates. For example, the Patent Document 1 discloses a method comprising steps of mutually laminating a copperplate with a red color, a copper alloy plate with a gold color, and a stainless steel plate with a silver color into a multistage form, surrounding the laminated metallic plates with supplement iron plates and hermetically welding a resultant product to isolate the product from the outside air, and heating the product at 800 to 850° C. in a heating furnace to be metallurgically laminated and made it adhere each other (that is, diffusion-joined), thereby to obtain a multi layered clad plate.

Further, the Patent Document 2 disclosed an exemplary method for obtaining a plate-like clad material comprising metallic phases with different color tones on a surface thereof, the method comprising the steps of: laminating an anti-corrosion steel plate such as a stainless steel and a copper alloy plate with different color tones such as brass, bronze, gold-copper alloy, Abyssinian gold, Mannheim gold, and Nurnberg gold; and sealing the resultant laminated plates with enclosure steels by heating the plates at 800-900° C. to be diffusion-joined. More specifically, the Patent Document 2 shows that a material produced by laminating stainless steels and gold-copper plates is surrounded by thin steel plates with 5 mm thickness to be sealed, and a plate-like clad material is obtained by heating the resultant product at 800° C. in a heating furnace, and then rolling it. As another example, the Patent Document 2 discloses that a stainless steel plate and an Abyssinian gold plate with a composition of Cu in 86.4%, Zn in 11.2%, Sn in 1.4% and Au in 0.1% are laminated, and the resultant product is surrounded by thin steel plates of 5 mm thickness to be sealed, put the product in a heating furnace to be heated at 850° C., and rolled to obtain a plate-like clad material. Further, is also disclosed that a stainless steel plate and an aluminum gold plate with a composition of Cu in 96%, Al in 5% and Fe in 1% are laminated, and the resultant product is surrounded by thin steel plates of 1 mm thickness to be sealed, put in a heating furnace to be heated at 800° C., and rolled to obtain a plate-like clad material.

Similarly, the Patent Document 3 discloses that anti-rust metallic plate such as a ferrite based or an austenite based stainless steel, and a decorative metallic plate such as a Cu—Zn alloy based plate, a Cu—Sn alloy based plate, a Cu—Au alloy based plate and Cu—Al alloy based plate, are laminated, and joints of junction are sealed by a method such as hermetical welding (in Example section, thin steel plates with 5 mm thickness surround and seal the joints). Then, the resultant product is put in a heating furnace in the condition preventing the outside air from penetrating therein, to be heated up to 800 to 900° C. for conducting the diffusion-joining.

Further, the Patent Document 4 disclosed that a steel of which a predetermined surface is plated by tin or zinc is laminated with a copper or copper alloy plate, and the resulting product is heat-rolled in the condition preventing the outside air from penetrating through joint peripheries thereof, to diffusion-join the resultant product at a low temperature around a melting point of the plating metal. More specifically, copper plates are laminated on both sides of a steel plate of which both surfaces are plated with tin. The resulting product is surrounded by thin steel plates with 1 mm thickness, and joint parts thereof are hermetically welded. The resultant product is put in a heating furnace to be heated at 200° C., and then rolled to obtain a composite plate. Further, is also disclosed that brass plates are laminated on both sides of a steel plate of which both surfaces are plated with zinc, and the resultant product is covered by thin steel plates with 1 mm thickness, heated at about 450° C., and then rolled to obtain a composite plate.

Of methods using a plastic composition containing a precious metallic powder, a method disclosed in the Patent Documents 5 to 7 is proposed to create a metallic article produced by joining different metallic sinters. Note that the Patent Documents 5 to 7 describe that copper is included in precious metals. However, copper has a disadvantageous property that an anti-corrosion profile (anti-oxidation profile) of copper is greatly inferior to that of general precious metals such as gold, silver and platinum. In other words, copper or a copper alloy has a property that copper or a copper alloy is oxidized when copper or a copper alloy is heated in the oxidation atmosphere (or in the air).

The Patent Document 5 discloses a method comprising steps of forming plastic clay compounds each containing a precious metallic powder” in a plate shape, which turn different colors by sintering, laminating a plurality of plate shaped products, rolling up a resultant lamination into a roll shape, cutting off the resultant product, and sintering the cut materials.

A procedure described in the Patent Document 6 comprises steps of forming a plastic clay compound containing the first precious metallic powder in a plate shape, removing a plate part of the desired region, cramming a plastic clay compound containing the second precious metallic powder showing a different color into the removed plate part, and sintering the resultant product.

A procedure of the Patent Document 7 is a method comprising steps of pre-forming a plurality of plastic precious metal clay compounds in a block or plate shape, which turn different colors by sintering, joining the resulting products so that the patterns at front and rear sides thereof become different, and sintering the resulting product.

However, every technique described in the Patent Documents 5 to 7 is a method for joining the plastic clay compound in a so-called clay-like state capable of being plastically deformed, in a rough combination manner. In short, the technique is greatly restricted in designing because various patterns should be expressed using the plastic clay compound in the clay-like state. Further, every technique in the Patent Documents 1 to 3 does not provide a decorative metallic article which lacks sharp appearance of the pattern compared to the decorative metallic article obtained by the wood grain metal technique, resulting in failure at all so as to express the pattern created by the wood grain metal technique.

Further, the Patent Documents 5 to 7 do not sufficiently and clearly describe the sintering conditions. Particularly, the Patent Document 7 does not describe any of the atmosphere condition of in the sintering process.

The patent Documents 5 and 6 describe methods that plastic clay compound containing a pure gold powder is sintered in the air, that is, in the oxidation atmosphere, while a plastic clay compound containing a so-called K18 alloy made by mixing gold in 75.0 wt %, silver in 12.5 wt % and copper in 12.5 wt % is sintered in the argon atmosphere. In other words, it is disclosed that even though the clay compound containing the K18 alloy slightly containing copper only in 12.5 wt % is used, the sintering process thereof has to be conducted in the inert atmosphere.

However, even though both Patent Documents 5 and 6 propose a method that plastic clay compounds containing metallic powders with different color tones are sintered in the physically joined state, there is no description which sintering conditions should be used in the state that a plastic clay compound A containing a pure gold powder to be sintered in the oxidation atmosphere is joined with a plastic clay compound B containing copper such as a K18 alloy to be sintered in the inert atmosphere.

Furthermore, according to a reference document issued by the applicant of the Patent Documents 5 to 7, in order to sinter a shaped object made of the plastic clay compound containing powder of bronze which is a copper alloy including tin, a method is described that a shaped bronze object is placed on a bed of a reduction agent such as charcoal applied on an aluminum foil, and the shaped bronze object is covered by a stainless steel vessel and heated up to 860 ° C. for about 1 to 3 hr.

### PRIOR ART DOCUMENTS

### Patent Literatures

[Patent Document 1] Japanese Patent Application Publication No. S57-4434

[Patent Document 2] Japanese Patent Application Publication No. S55-36031

[Patent Document 3] Japanese Patent Application Publication No. S55-1986

[Patent Document 4] Japanese Patent Application Publication No. S34-6416

[Patent Document 5] Japanese Patent No. 2932648

[Patent Document 6] Japanese Patent No. 2924139

[Patent Document 7] Japanese Patent No. 3389613

### DISCLOSURE OF THE INVENTION

### Problems to be Solved by the Invention

However, a wood grain metal technique is a high-grade and special chasing method that needs significant efforts to master. Further, it is required to prepare a condition in the reduction atmosphere. Accordingly, the wood grain metal technique is not a method at all to be mastered at a further education school or the like.

Further, according to a procedure described in the Patent Document 1, a plurality of laminated metallic plates are covered with supplemental iron plates, to be hermetically welded so as to isolate the resulting product from the outside air. Herein, an operation of covering the metallic plates with the supplemental iron plates in the state of pressuring the plurality of metallic plates, requires extremely difficult operational technique. Together with this, hermetical welding requires a high-grade skill. Accordingly, the conventional wood grade metal technique requires special equipment and a device as well as a high-grade skill.

Similarly to the above mentioned procedure, in the procedures described in the Patent Documents 2 to 4, a plurality of metallic plates are isolated from the outside air by surrounding peripheral parts of the plurality of metallic plates with thin steel plates and hermetically welding the resulting product. Similarly to the Patent Document 1, an operation of covering the metallic plates with the supplemental iron plates in the state of pressuring the plurality of metallic plates, requires extremely difficult operational technique. Together with this, hermetical welding also requires a high-grade skill. Accordingly, the conventional wood grain metal technique requires special equipment and a device as well as a high-grade skill.

Further, decorative metallic articles produced by the techniques described in the Patent Documents 5 to 7 do not reach at all a decorative metallic article obtained by the above mentioned wood grain metal technique, in comparison with each other.

Moreover the Patent Document 5 describes a procedure comprising steps of laminating two kinds of clay compounds each having a plate shaped form, rolling up the resulting product to a roll shaped form, cutting off the roll shaped product, and sintering the cutting off materials. The procedure might be looked as a wood grain metal “like” technique. However, the finally obtained decorative article is a product only produced by the steps of: laminating the plate like compositions, rolling up the laminate to the roll shaped object, cutting off the roll shaped object in the clay-like state to pieces, and sintering the cut off pieces. Therefore, when compared to the decorative metallic article obtained through the wood grain metal technique, the above mentioned product lacks sharpness of the pattern thereof, thereby not to reach at all the decorative article representing a pattern produced by the wood grain metal technique, resulting in the production of a severely simple metallic article.

Furthermore, as mentioned hereinbefore, sintering conditions of the plastic copper containing clay compound containing at least one kind of powder metal selected from copper and a copper alloy, are known to be basically performed in the inert atmosphere, that is, in the reduction atmosphere. In contrast, what conditions or procedures should be used to obtain a decorative metallic article by sintering a composite shaped object without damaging the shaping of the object, have not been known specifically, when a composite shaped object produced by joining a plastic copper containing clay compound with a plastic precious metal containing clay compound including a precious powder metal such as silver, which has an anti-oxidation profile not oxidized in the air in the sintering process.

From the viewpoint of the drawbacks as mentioned above, the present inventors have been investigating to provide a method for producing a decorative metallic article and the decorative metallic article, used in jewelry goods, ornaments and clothing accessories or the like, the decorative metallic article being produced by joining a plastic copper containing clay compound including at least one kind of powder metal selected from copper or a copper alloy having a variety of colors such as a brown color of copper, a bronze color and a nickel color of a copper and nickel alloy, with a plastic silver clay compound containing at least one kind of powder metal selected from silver or a silver alloy. Accordingly, the present invention is finally realized.

Herein, an object of the present invention is to provide a method for producing a decorative metallic article having a wood grain metal pattern (or mokumegane pattern) comprising a sintered copper part produced by sintering a plastic copper containing clay compound and a sintered silver part produced by sintering a plastic silver containing clay compound.

### Means for Solving the Problems

Here, a method for producing a decorative metallic article having a wood grain metal pattern in the first aspect of the present invention comprises:

[Plate forming Step] of forming a plastic copper containing clay compound including an organic binder and at least powder metal selected from copper and a copper alloy, and a plastic silver containing clay compound including an organic binder and at least powder metal selected from silver and a silver alloy, each formed in a plate-like shape, thereby to produce a copper plate and a silver plate;

[Multi Layering And Adhesion Step] of laminating the copperplate and the silver plate one another by applying water to the joint parts thereof, and adding a load to the resulting laminate to elongate the laminated plates so as to reduce a thickness thereof in 10% and more, thereby to adhesively paste the plates together;

[Decorative Object Forming Step] of forming a multi layered decorative copper-silver object by using the multi layered plates after conducting the [Multi Layering And Adhesion Step];

[Multi Layered Decorative Copper-Silver Object Drying Step] of drying the multi layered decorative copper-silver object;

[Wood Grain Metal Pattern Forming Step] of forming notches by cutting or polishing a surface of the dried multi layered decorative copper-silver object to allow a wood grain metal pattern to appear; and

[Sinter Producing Step] of obtaining a decorative metallic article by sintering the resulting decorative object on which the notches are formed.

According to the method for producing the decorative metallic article having such a wood grain metal pattern, the method comprises steps of: forming the copper plate and the silver plate respectively by the plastic copper containing clay compound and the plastic silver containing clay compound; laminating the plates one another; elongating the laminated plates by adding a load to adhesively paste together; forming the multi layered decorative copper-silver object by using the multi layered plates; forming notches after drying the formed decorative object to allow the wood grain metal pattern to appear, and sintering the resulting decorative object. This method allows a decorative metallic article approaching to a decorative article produced by the wood grain metal technique of the traditional handcrafts to be easily obtained without mastering a high-grade and special chasing skill.

Further, the [Multi Layering And Adhesion Step] comprises not only laminating and pasting plates simply, but laminating the copper plate and the silver plate one another by applying water to the surfaces thereof, and then elongating the laminated plates to reduce the thickness in 10% or more, thereby to adhesively paste the laminated plates together, forming the multi layered decorative copper-silver object by using the multi layered plates, and forming the notches so that the wood grain metal pattern appears after drying the formed multi layered decorative copper-silver object. Thus, this step allows a multi layered cross-section of the multi layered decorative copper-silver object to comprise a densely fine appearance and prevent separation of the multi layered plates each other, thereby to forma gorgeous wood grain metal pattern on the decorative metallic article.

Moreover, the wood grain metal pattern is formed (or represented) by the notches created by the cutting process after drying the multi layered decorative copper-silver object, allowing the wood grain metal pattern to be freely formed as crossing a thickness direction of the object. In addition, the drying process of the multi layered decorative copper-silver object facilitates a cutting performance to be improved, and sharp notches or extremely fine notches to be remarkably easily formed, resulting in the pattern approaching to that created by the wood grain metal technique of the traditional handcrafts.

In contrast, the Patent Document 5 discloses a method for obtaining a metallic article, comprising steps of: laminating a plurality kinds of plastic compositions as plate forms respectively, containing precious powder metals which respectively turn different color tones by sintering as mentioned hereinbefore; rolling up these plates to produce a roll shaped mixed object; cutting off the roll shaped mixed object in the clay-like state so as to expose respective plastic compositions; and sintering the resultant cut off pieces to solidify the pieces, thereby to obtain a metallic article.

Hereby, the Patent Document 5 discloses a method comprising steps of only forming a roll shaped cross-section of the product, and simply rolling up the plurality of plates. Accordingly, the cross-section of the resulting product is hardly recognized to have a wood grain metal pattern, but only appears as a roll cake structure, resulting in an ultimately insipid decorative article as an art craft.

The decorative object on which notches are formed may be sintered in the reduction atmosphere or in the oxidation atmosphere. The sintering in the reduction atmosphere requires complicated procedure. For example, the inert gas such as argon gas or nitrogen gas has to continuously flow during the sintering process, and a reduction agent such as charcoal is put in a sealed vessel together with a decorative object, and the resultant mixture in the vessel is heated from the outside. Therefore, the decorative object is preferably sintered in the oxidation atmosphere (or in the air). When the decorative object is sintered in the oxidation atmosphere, it is particularly preferable to restrict an average mean diameter of the powder included in at least one powder metal selected from copper or a copper alloy to 10 μm or less.

Note the above mentioned terms “silver alloy” of the present invention mean an alloy of which silver content is 80 wt % or more including, for example, silver of grade 950, grade 925, grade 900 and grade 800 authorized by the Japan Quality Authorization System. Such a “silver alloy”, for example, includes a silver-Pd alloy or the like, of which sulfurization resistance performance is improved.

On the other hand, the above mentioned terms “copper alloy” of the present invention mean an alloy of which copper content is 80 wt % or more including, for example, bronze, gunmetal and a copper-nickel alloy or the like. Note the copper alloy containing no copper oxide is preferable. Hereby, it is possible to prevent the resultant sinter from becoming a porous product by containing no copper oxide in the copper alloy.

Herein, according to the present invention, the terms “air sintering” means that the sintering process is conducted in the air, and identical to the sintering process conducted in the oxidation atmosphere. Further, the terms “reduction atmosphere” are construed as an inside state of a sealed vessel in which a reduction agent such as charcoal (that is, an agent tends to be more easily oxidized than the shaped copper object in the heating process) is put together with the shaped copper object, and the mixture in the sealed vessel is heated from the outside. Thus, the terms “reduction atmosphere” are construed as identical to the inert atmosphere such as the argon gas atmosphere, and include such atmosphere.

According to the second aspect of the present invention, a method for producing a decorative metallic article having a wood grain metal pattern includes the [Multi Layering And Adhesion Step] comprising processes of: laminating the copper plate and the silver plate by applying water to the joint surfaces thereof; adding a load onto the laminate to elongate a thickness of the laminated plates to be reduced in 10% or more; adhesively pasting the laminated plates together to form a copper-silver plate; cutting or folding back the copper-silver plate; laminating the resultant copper-silver plates by applying water to the joint surfaces, then, adding a load onto the resulting laminate to elongate a thickness of the laminated plates to be reduced in 10% or more, thereby to obtain a multi layered copper-silver plate; further repeatedly conducting the operations from the above mentioned laminating to pasting at least one time, and forming the multi layered copper-silver plate finally.

According to the second aspect of the present invention, the method for producing the decorative metallic article having the wood grain metal pattern, the multi layered plate obtained in the [Multi Layering And Adhesion Step] comprises extremely a number of layers, and a thickness of each layer may be elongated uniformly, allowing a more gorgeous wood grain metal pattern to be formed.

According to the third aspect of the present invention, a method for producing a decorative metallic article having a wood grain metal pattern comprises a step of elongating the laminated plate so that a thickness of the laminated plate is reduced in 20 to 80%, thereby to adhesively paste the laminated plate layers each other.

According to the third aspect of the present invention, the method for producing the decorative metallic article having the wood grain metal pattern allows a more densely fine and gorgeous wood grain metal pattern to be formed.

According to the fourth aspect of the present invention, a method for producing a decorative metallic article having a wood grain metal pattern comprises steps of:

Forming a multi layered copper-silver ring by shaping the multi layered plates after conducting [Multi Layering And Adhesion Step], into a ring shape in the [Decorative Object Forming Step],

cutting slantwise both circular peripheries of a dried multi layered copper-silver ring with alternating the left and right side peripheries so that the wood grain metal pattern appears, and

forming notches at the both circular peripheries of the ring with alternating the left and right sides thereof.

According to the fourth aspect of the present invention, the method for producing the decorative metallic article having the wood grain metal pattern allows a ring and a bracelet having a densely fine and gorgeous wood grain metal pattern to be easily produced.

According to the fifth aspect of the present invention, a method for producing a decorative metallic article having a wood grain metal pattern comprises steps of:

forming a multi layered decorative copper-silver object by cutting at least a periphery of the multi layered plates after conducting the multi layering and adhesion step, in the decorative object forming step,

masking a surface of a dried copper-multi layered decorative object by a masking sheet cut off to fit a predetermined pattern in the wood grain metal pattern forming step, and

forming notches by cutting or polishing a surface of the dried multi layered decorative copper-silver object by a sandblast, so that the wood grain metal pattern appears to fit the cut off pattern of the masking sheet.

According to the fifth aspect of the present invention, the method for producing the decorative metallic article having the wood grain metal pattern allows a pendant or a broach having a densely fine and gorgeous wood grain metal pattern to be easily produced.

According to the sixth aspect of the present invention, a method for producing a decorative metallic article having a wood grain metal pattern comprises a step of drying the multi layered decorative copper-silver object by natural drying or heat drying at a drying temperature of 80 to 180° C. and in a drying time for 10 to 60 min.

According to the sixth aspect of the present invention, the method for producing the decorative metallic article having the wood grain metal pattern, the heat drying process can be conducted by a drying machine, an electric furnace or a dryer or the like. The heat drying process is preferably conducted at a drying temperature of 80 to 120° C. and in a drying time for 20 to 40 min.

The completion of the drying process may be a state that when the surface of the multi layered decorative copper-silver object is cut off so as to allow the wood grain metal pattern to appear by cutting or polishing to form the notches, the surface thereof may be dried as capable of being satisfactorily cut and polished. Preferably, the completion of the drying process is a state that steam is not emitted from the multi layered decorative copper-silver object heated at 80 to 120° C. The steam emission can be detected by determining whether dew concentrates or not on a glass plate or a stainless steel plate when the main body of the shaped object or the multi layered copper-silver object is close to the glass plate or the stainless steel plate. If the dew is not concentrated, the drying process may be regarded as completed.

Note the drying process may be conducted by natural drying, and in that case, drying for one day or more is particularly preferable. The completion of drying may be determined that dew is not concentrated by heating with a dryer or the like as mentioned above.

According to the seventh aspect of the present invention, a method for producing a decorative metallic article, in the above mentioned first or second aspect, the sinter producing process is conducted in the air sintering.

According to the seventh aspect of the present invention, the method for producing a decorative metallic article comprises a step of sintering in the air and not sintering in the reduction atmosphere as a conventional procedure. Therefore, this may avoid complicated procedures of flowing the inert gas such as argon gas and nitrogen gas continuously, and putting a reduction agent such as charcoal together with the shaped copper object in a sealed vessel to heat the mixture in the vessel from the outside. The above mentioned advantages facilitate the method for producing a decorative metallic article to be more easily applicable in a further education school or the like.

According to the eighth aspect of the present invention, a method for producing a decorative metallic article having a wood grain metal pattern comprises the sinter producing step that is conducted at a sintering temperature of 660 to 770° C. and in a sintering time for 3 to 40 min.

According to the eighth aspect of the present invention, in the method for producing the decorative metallic article, it is particularly preferable to conduct the sintering process at a lower temperature and in a shorter time than the temperature and time of sintering singly the shaped copper object or singly the shaped silver object.

When the decorative object is sintered in the air, an electric furnace may be pre-heated in advance at the sintering temperature, the decorative object maybe put into the electric furnace kept at the sintering temperature, and thereafter keeping the temperature at the predetermined temperature to complete the sintering process. Finally, the decorative object maybe taken out from the electric furnace thereby to be rapidly cooled.

According to the ninth aspect of the present invention, in a method for producing a decorative metallic article having a wood grain metal pattern,

at least one kind of the powder metal selected from copper and a copper alloy included in the plastic copper containing clay compound is a mixed copper powder consisting of a first powder with a mean particle diameter of 0.1 to 4.0 μm in 25 to 75 wt %, and the remainder of a second powder with a mean particle diameter in the range from more than 4.0 μm to 10 μm or less, and

at least one kind of the powder metal selected from silver and a silver alloy included in the plastic silver containing clay compound is a mixed silver powder consisting of a first powder with a mean particle diameter of 0.1 to 4.0 μm in 25 to 75 wt %, and the remainder of a second powder with a mean particle diameter in the range from more than 4.0 μm to 40 μm or less.

According to the ninth aspect of the present invention, in the method for producing the decorative metallic article having the wood grain metal pattern, at least one kind of the powder metal selected from copper and a copper alloy included in the plastic copper containing clay compound is limited to the powder of which mean particle diameter is 10 μm or less. Further, the powders included in the plastic copper containing clay compound and the plastic silver containing clay compound are made as specific mixed powders having different mean particle diameters respectively. Then, the plastic copper containing clay compound is joined with the plastic silver containing clay compound to conduct steps of shaping and drying to form a multi layered decorative copper-silver object having a wood grain metal pattern. Note even though the resulting decorative object is sintered in the air at the predetermined sintering temperature and in the predetermined time, the decorative object can be sintered without “damaging” the shaping, which allows a copperplate sintering part and a silver plate sintering part to obtain steady strength required for a sintered article for the craft or decorative use.

Each of these plastic copper containing clay compound and plastic silver containing clay compound includes specific mixed powders with different particle diameters. This allows the coefficient of linear contraction of each shaped object after sintering to be suppressed at a similarly low level, resulting in no peeling and no damaging of the shape of the sinters after sintering, since both contractions of the decorative sinters are not so greatly different.

Here, even though the surface of the shaped copper sinter part is very slightly oxidized in the air sintering, the inside part of the shaped copper sinter part is not influenced by the oxidation. Accordingly, this facilitates an oxidation film formed on the surface of the shaped copper sinter part to be very easily detached, allowing the appearance of the shaped copper sinter part to be sufficiently accepted as a sintered article for craft or decorative use. Note there is a rare case that it is preferable to sinter the shaped silver object in the reduction atmosphere depending on a silver alloy component included in the plastic silver containing composition, with respect to the shaped silver sinter part. However, in general, if the shaped silver object may be sintered in the air, the sintering thereof may be performed without any problem.

Therefore, the shaped object is not sintered in the reduction atmosphere as a conventional procedure. Hereby, this may avoid complicated procedures of flowing the inert gas such as argon gas and nitrogen gas continuously, and putting a reduction agent such as charcoal together with the shaped copper object in a sealed vessel to heat the mixture in the vessel from the outside. The above mentioned advantages facilitate the method for producing a decorative metallic article to be more easily applicable to a further education school or the like.

Further, in the present invention, the plastic copper containing clay compound is joined with the plastic silver containing clay compound to form the multi layered decorative copper-silver object, and the resulting multi layered decorative copper-silver object is simultaneously (or all at once) sintered in the air. This avoids the sintering equipment to be used numerous times, resulting in extremely efficient method.

Here, the terms “mean particle diameter” of the copper powder, the copper alloy powder, the silver powder and the silver alloy powder used in the present invention are also referred to as an average grain diameter, an average particle diameter, a median diameter, a median size, or a 50% particle size; are typically represented as “D50”; and mean a particle size corresponding to 50% of a cumulative distribution curve. More specifically, the mean particle diameter is a value of D50 of a particle size distribution obtained by using a laser diffraction-type particle size distribution measurement device with tri-laser scattered light detection mechanism (manufactured by Microtrac, Inc.) and setting measurement conditions thereof at [particle permeability: reflection] and [spherical/nonspherical: nonspherical] (that is, when the particle permeability is set to reflection and the selection of spherical/nonspherical is set to nonspherical).

According to the tenth aspect of the present invention, a decorative metallic article having a wood grain metal pattern is produced by the production method described in the first or second aspects.

According to the tenth aspect of the present invention, the decorative metallic article having the wood grain metal pattern shows a clear contrast of the color tones between the copper sinter made from the plastic copper containing composition comprising various color tones including a brown color of copper, a bronze color of a copper-tin alloy, a white color of a copper-nickel alloy, and the silver sinter made from the plastic silver containing composition comprising various color tones such as silver white and silver colors, and the wood grain metal pattern appears at the notches. This allows the appearance of the decorative metallic article to be sufficiently attractive as jewelry goods, ornaments, and clothing accessories or the like, whereby the decorative metallic article may become well accepted as a sintered article for craft or decorative use.

### Advantageous Effects of the Invention

According to the method for producing the decorative metallic article having the wood grain metal pattern of the present invention, the method comprises the steps of: forming the copper plate and the silver plate respectively by the plastic copper containing clay compound and the plastic silver containing clay compound, laminating the plates one another, elongating the laminated plates by adding a load to adhesively paste together, forming the multi layered decorative copper-silver object by using the multi layered plates, forming the notches to allow the wood grain metal pattern to appear after drying the formed decorative object, and sintering the resulting decorative object. Therefore, this method allows a decorative metallic article approaching to a decorative article produced by the wood grain metal technique of the traditional handcrafts to be easily obtained without mastering a high grade and special chasing technique.

Further, the cross-section of the multi layered decorative copper-silver object becomes so densely fine as causing no separation of the layers each other, thereby to form a gorgeous wood grain metal pattern. Moreover, it is possible to freely and easily select the shaping and pattern of the decorative article in the method of the present invention, compared to the method of the Patent Document 5 that only forms a roll-cake shaped decorative article. The above mentioned advantages provide particularly excellent feature with the method of the present invention.

Further, according to the second aspect of the present invention, the method for producing the decorative metallic article having the wood grain metal pattern is capable of forming the multi layered plate with many layers, and elongating the multi layered plate to have the thickness of each layer uniform, which allows a more beautiful wood grain metal pattern to be formed.

### BRIEF DESCRIPTION OF THE DRAWINGS

FIG. 1 is a perspective diagram showing a copper plate obtained in the plate forming step in the illustrated example.

FIG. 2 is a perspective diagram showing a silver plate obtained in the plate forming step in the illustrated example.

FIG. 3 is a perspective diagram showing a view in which a small amount of water is applied to the joint surface performed in the multi layering and adhesion step in the illustrated example.

FIG. 4 is a perspective diagram showing a composite plate obtained in the multi layering and adhesion step in the illustrated example.

FIG. 5 is a perspective diagram showing a composite plate obtained in the multi layering and adhesion step is cut in halves in the illustrated example.

FIG. 6 is a perspective diagram showing a multi layered plate obtained in the decorative object forming step in the illustrated example.

FIG. 7 is a perspective diagram showing a state in which the multi layered plate is rolled up to a wood shaft in the decorative object forming step in the illustrated example.

FIG. 8 is a perspective diagram showing a state in which notches are formed by a second-cut file in the wood grain metal pattern forming step in the illustrated example.

FIG. 9 is a perspective diagram showing a state in which a sintered object is rapidly cooled in the surface oxidation film removing step in the illustrated example.

FIG. 10 is a perspective diagram showing a state in which the sintered object is treated in the pickling process in the surface oxidation film removing step in the illustrated example.

FIG. 11 is a perspective diagram showing a decorative metallic article (or ring) in the illustrated example.

FIG. 12 a perspective diagram showing a photograph substituting the diagram of the decorative metallic article produced in Example 1.

FIG. 13 a perspective diagram showing a photograph substituting the diagram of the decorative metallic article produced in Example 3.

### BEST MODE FOR CARRYING OUT THE INVENTION

First, a plastic copper containing clay compound and a plastic silver containing clay compound of the present invention will be explained.

The plastic copper containing clay compound includes an organic binder and at least a powder metal selected from copper and a copper alloy.

Further, the plastic silver containing clay compound includes an organic binder and at least a powder metal selected from silver and a silver alloy.

Herein, the plastic copper containing clay compound preferably used is at least one kind of a powder metal selected from copper and a copper alloy, comprising an organic binder and a mixed copper powder consisting of a first copper powder with a mean particle diameter of 0.1 to 4.0 μm in 25 to 75wt %, and the remainder of a second copper powder with a mean particle diameter in the range from more than 4.0 μm to 10 μm or less.

Further, the plastic silver containing clay compound preferably used is at least one kind of a powder metal selected from silver and a silver alloy, comprising an organic binder and a mixed silver powder consisting of a first silver powder with a mean particle diameter of 0.1 to 4.0 μm in 25 to 75wt %, and the remainder of a second silver powder with a mean particle diameter in the range from more than 4.0 μm to 40 μm or less.

As mentioned hereinbefore, various color tones of copper based metals have been well known, for example, copper has a brown color, and copper alloys have a bronze color of a copper-tin alloy, a white color of a copper-nickel alloy.

Further, silver has a silver white color. Additionally, silver alloys may be used including, for example, silver of grade 950, grade 925, grade 900 and grade 800 authorized by the Japan Quality Authorization System as mentioned hereinbefore, and a silver-Pd alloy in which Pd in 1% is added.

Manufacturing methods of those copper powder, copper alloy powder, silver powder, and silver alloy powder are not particularly specified, including gas atomization and reduction methods. Of the aforementioned methods, a method for manufacturing substantially spherical particles is preferably utilized.

The shaped decorative object by joining the plastic copper containing clay compound and the plastic silver containing clay compound each of which including a specific mixed powder containing different mean particle diameters as mentioned hereinbefore, may be sintered in the air. Hereby, the shaped copper sinter part and the shaped silver sinter part maybe obtained, each having steady strength required for craft or decorative use. Further, the contraction of each sinter (or shaped sinter part) after the sintering process may be approximately close, allowing the decorative object sinter to avoid peeling and damaging of the shape after the sintering process. Such peeling and damaging may be caused in the case that one of the sinters is too more largely contracted than the other sinter.

Further, even though the surface of the shaped copper sinter part is very slightly oxidized in the air sintering, the inside part of the shaped copper sinter part is not influenced by the oxidation. Accordingly, this facilitates the oxidation film formed on the surface of the shaped copper sinter part to be easily removed by the rapid cooling, pickling, and polishing treatments. Hereby, these removing treatments of the oxidation film allow the appearance of the shaped copper sinter part to be sufficiently accepted as a sintered article for craft or decorative use.

Moreover, regarding at least one kind of the powder metal selected copper and a copper alloy and at least one kind of the powder metal selected silver and a silver alloy, preferably, the former copper powder metal may be a mixed copper powder containing a first copper powder with a mean particle diameter of 0.5 to 4.0 μm in 25 to 75 wt % and the remainder of a second copper powder with a mean particle diameter in the range from more than 4.0 μm to 10μm or less. Further, the latter silver powder metal may be a mixed silver powder containing a first silver powder with a mean particle diameter of 0.5 to 4.0 μm in 25 to 75 wt % and the remainder of a second silver powder with a mean particle diameter in the range from more than 4.0 μm to 30 μm or less.

Furthermore, more preferably, the mixed copper powder may contain the first copper powder with a mean particle diameter of 2.0 to 3.0 μm in 30 to 70 wt % and the remainder of the second copper powder with a mean particle diameter of 5 μm to 10 μm, and the mixed silver powder may contain the first silver powder with a mean particle diameter of 2.0 to 3.0 μm in 30 to 70 wt % and the remainder of the second silver powder with a mean particle diameter of 5 μm to 20 μm.

The aforementioned organic binder is not limited specifically. However, the organic binder may preferably include at least one member selected from the following: a cellulose-based binder such as methylcellulose, ethylcellulose, hydroxyethylcellulose, hydroxypropylcellulose, hydroxypropylmethylcellulose, and carmellose (carboxymethylcellulose), sodium carboxymethyl cellulose, potassium carboxymethylcellulose, and calcium carboxymethylcellulose; an alginic acid-based binder such as sodium alginate; a polysaccharide-based binder such as starch, dogtooth violet starch, wheat flour, British gum, xanthane gum, dextrin, dextran, and pullulan; an animal-derived binder such as gelatin; a vinyl-based binder such as polyvinyl alcohol and polyvinylpyrrolidone; an acryl-based binder such as polyacrylic acid and polyacrylate ester; and other resin-based binder such as polyethylene oxide, polypropylene oxide, and polyethylene glycol, or the like. If the cellulose-based binder is used, a water-soluble cellulose-based binder is most preferably used.

Further, the following additive may be added to the organic binder where necessary.

Namely, the additive includes one or more members selected from the following: organic acid (oleic acid, stearic acid, phthalic acid, palmitic acid, sebacic acid, acetylcitric acid, hydroxybenzoic acid, lauric acid, myristic acid, caproic acid, enanthic acid, butyric acid, capric acid, citric acid); organic acid ester such as n-dioctyl phthalate and n-dibutyl phthalate (organic acid ester having a methyl group, ethyl group, propyl group, butyl group, octyl group, hexyl group, dimethyl group, diethyl group, isopropyl group, and isobutyl group); higher alcohol (octanol, nonanol, decanol); polyol (glycerin, arabite, sorbitan, diglycerin, isoprene glycol, 1,3-butylene glycol); ether (dioctyl ether, didecyl ether); lignin which may be cited as a concrete example of the reticular macromolecular substance that results from the condensation of the component unit having phenylpropane as a backbone; liquid paraffin; and oil, or the mixture thereof (for example, olive oil containing rich oleic acid), etc. The additive is added so as to improve plasticity or prevent the plastic copper containing clay compound or the plastic silver containing clay compound from sticking to a hand during shaping. Further, the lignin and glycerin above-cited as the additive give an appropriate level of a water retention property.

The additive also includes an anionic, cationic, nonionic, or any other surfactant. The surfactant improves miscibility between the copper or silver powder and the organic binder, and improves a water retention property.

Of the above mentioned organic binders, the water-soluble cellulose-based binder gives plasticity to the plastic copper containing composition and the plastic silver containing composition. The polyethylene oxide gives a high viscosity at a low concentration and increases adhesiveness in its liquid form. The sodium alginate gives an appropriate level of a water retention property, similarly to glycerin and also helps increase adhesiveness. Further, the polyacrylate ester and polyacrylic acid additionally increase adhesiveness.

As mentioned above, the water-soluble cellulose-based binder gives plasticity to the plastic copper containing clay compound and the plastic silver containing clay compound. The water-soluble cellulose-based binder includes: methylcellulose, hydroxyethylcellulose, hydroxylpropyl-cellulose, hydroxypropylmethylcellulose, sodium carboxy-methylcellulose, potassium carboxymethylcellulose, calcium carboxymethylcellulose, etc, and is used by being dissolved in water.

If the aforementioned water-soluble cellulose-based binder is used as the organic binder, the amount of the organic binder in the plastic copper containing clay compound or the plastic silver containing clay compound is preferably in the range from 0.1 to 4 wt % by the dry solids content excluding water as the solvent. In this case, if the amount of the organic binder is less than 0.1 wt %, it is difficult to obtain a homogeneous plastic copper containing clay compound or a homogeneous plastic silver containing clay compound. Further, the strength after application or drying becomes disadvantageously lowered. If the amount of the organic binder is more than 4 wt %, the shrinkage ratio of the obtained object increases and the object tends to easily crack. Accordingly, the amount of the organic binder is preferably in the range from 0.1 to 4 wt %.

If polyethylene oxide is used, the polyethylene oxide preferably has a molecular weight from a hundred thousand to several millions and is used in the amount in the range from 0.1 to 3 wt %.

Further, if a surfactant is used, the amount thereof is preferably in the range from 0.03 to 3 wt %. If oil is used, the amount thereof is preferably in the range from 0.1 to 3 wt %.

Further, an appropriate amount of water is added to the above mentioned plastic clay compound. If the amount of added water is too small, the clay compound becomes hard resulting in difficult to be shaped, while if the amount of added water is too much, it is difficult to keep the shape of the product after shaping. Herein, the plastic copper containing clay compound and the plastic silver containing clay compound used in the present invention can be prepared as a clay-like form, a paste-like form or a slurry-like form, by adjusting the content of water.

In the preferable composition, a metallic powder is contained in 75 to 99 wt % in both plastic clay compounds. If the content of the metallic powder is too small, the shrinkage ratio increases to obstruct the sintering process, while if the content thereof is too much, hereby the contents of the organic binder and water decrease to obstruct the shaping.

As a sintering accelerator, a powder of Bi, Se, Sb, In, Sn, and Zn or an alloy powder thereof may be added to the plastic composition.

Further, as an adhesiveness improver, a glass powder or a metallic compound powder selected from lead carbonate, lithium carbonate, zinc oxide, phosphoric acid, sodium carbonate, vanadium oxide, sodium silicate, phosphate salt, or the like may be added to the plastic clay compound.

Further, an organic additive maybe added so as to improve the plasticity of the clay compound. The organic additive includes lignin which may be cited as a concrete example of the reticular macromolecular substance that results from the condensation of the component unit having phenylpropane as a backbone, glycerin, diglycerin, isoprene glycol, 1,3-butylene glycol, liquid paraffin, alcohols, oil, phthalic acid, n-dioctyl phthalate, n-dibutyl phthalate, and polyvinyl alcohol. Further, a surfactant and a surface-active agent may be also added where necessary.

Moreover, a metal oxide such as zirconium oxide may be added so as to prevent the deformation of the resultant product in the sintering process. That is, the addition of a metal oxide allows the sintering rate to be delayed, which results in a formation of a gas diffusion passage through which gas generated when the organic binder burns, diffuses to the outside of the clay compound.

Next, will be explained each step of the method for producing the decorative metallic article of the present invention to obtain the decorative object sinter, by joining the plastic copper containing clay compound with the plastic silver containing clay compound, which is described in the first aspect of the present invention; the method comprising: [Plate Formation Step], [Multi Layering And Adhesion Step], [Decorative Object Forming Step], [Multi Layered Decorative Copper-Silver Object Drying Step], [Wood Grain Metal Pattern Forming Step], and [Sinter Producing Step].

[Plate Formation Step]

In the step, the plastic copper containing clay compound including an organic binder and at least one kind of a powder metal selected from copper and a copper alloy, and the plastic silver containing clay compound including an organic binder and at least one kind of a powder metal selected from silver and a silver alloy, are respectively formed in a plate-like shape, thereby to form a copper plate and a silver plate.

In the step, the copper plate and the silver plate to be produced are formed having a substantially same size and thickness in many cases. However, it is not necessary to produce both plates with a same thickness. Both plates may be intentionally formed to have different thicknesses.

[Multi Layering and Adhesion Step]

In the step, the copper plate and the silver plate are laminated to one another by applying water to joint surfaces of the plates, and then a load is added to the laminated plates so as to elongate the laminated plates by a roller or the like so that a thickness of the laminated plates decreases in 10% or more, thereby to adhesively paste the laminated plates.

If the above mentioned operation is not conducted, in which the copper plate and the silver plate are laminated one another by applying water to joint surfaces of the plates, and then a load is added to the laminated plates so as to elongate the laminated plates so that a thickness of the laminated plates decreases in 10% or more, in the [Wood Grain Metal Pattern Forming Step] described hereinafter, a multi layered cross-section of the multi layered decorative copper-silver object does not become densely fine. Further, there may be a separated layer part each other in the laminated multi layers. The above mentioned drawbacks may cause a defect in the wood grain like pattern.

The multi layering and adhesion step appears similarly to the step of producing and laminating plates at room temperature as described in the Patent Document 5. However, the step of the document does not include the operation that the copper plate and the silver plate are laminated to one another by applying water to joint surfaces of the plates, and then a load is added to the laminated plates so as to elongate the laminated plates by a roller or the like so that a thickness of the laminated plates decreases in 10% or more. In this regard, the step of the document tends to cause separation between the laminated multi layers. Thus, the step of that document should be regarded as a completely different step from the present invention.

Further, the multi layering and adhesion step of the present invention corresponds to operations of forming one sheet of a ground metal, through diffusion-joining plates and flattening the resultant plate by beating it with a hammer in the wood grain metal technique of the traditional handcrafts. Those operations of the diffusion-joining and the beating by a hammer are extremely dangerous and heavy labor respectively, while the multi layering and adhesion step of the present invention needs little labor to be extremely easily performed.

According to the second aspect of the present invention, in the [Multi Layering And Adhesion Step], the copperplate and the silver plate are laminated one another by applying water to the joint surfaces of the plates, and then a load is added to the laminated plates so as to elongate the laminated plates so that a thickness of the laminated plates decreases in 10% or more, thereby to form the copper-silver plate. Further, the copper-silver plate is cut off or folded back, and the resultant copper-silver plates are laminated by applying water to the joint surfaces, and then, a load is added to elongate the laminated plates so that s thickness of the laminated copper-silver plates decreases in 10% or more, thereby to adhesively paste together for obtaining a multi layered copper-silver plate. The above mentioned operation is repeated at least one time to form the multi layered plate.

Such a multi layered plate obtained in the [Multi Layering And Adhesion Step] described in the second aspect of the present invention allows the thickness of each layer of the multi layered plate to be uniformly elongated, thereby to form a more gorgeous wood grain metal pattern.

Further, according to the third aspect of the present invention, in the [Multi Layering And Adhesion Step], the laminated plates are elongated so that the thickness of the laminated plates decreases in 20 to 80%, thereby to adhesively stick? together.

According to the third aspect of the present invention, the [Multi Layering And Adhesion Step] allows a more densely fine and gorgeous wood grain metal pattern to be formed.

[Decorative Object Forming Step]

In the step, a multi layered decorative copper-silver object is formed by using the multi layered plate produced in the [Multi Layering And Adhesion Step].

A specific procedure for forming a multi layered decorative copper-silver object using the multi layered plate is not particularly limited and various modifications may be used. In this regard, it is not always necessary to shape an object three-dimensionally. A flat shaped object may be applicable.

The decorative object forming step in the Patent Document 5 comprises a process of only rolling up the laminated plates to produce a cylindrical mixed body. Hereby, the decorative object forming step of the present invention is not substantially conducted in the method of the Patent Document 5.

Further, regarding the decorative object forming step, in a wood grain metal technique of the traditional handcraft, an object may be shaped using a sheet of a ground metal after diffusion-joining a plurality of plates to form a single sheet of the ground metal. However, it should be noted that the operation for shaping a metallic plate material requires an extremely larger power than the operation for shaping a clay-like multi layered plate. That is, the former traditional operation needs heavy labor, while the decorative object forming step of the present invention needs little labor and may be performed extremely easily.

[Multi Layered Decorative Copper-Silver Object Drying Step]

In the step, the multi layered decorative copper-silver object is subjected to a drying process. The drying conditions are not particularly limited. However, natural drying or heat-drying at the drying temperature of 80 to 180° C. and in the drying time for 10 to 60 min is preferably used. The heat-drying may be conducted by a drying machine, an electric furnace, and a dryer or the like. The preferable conditions comprise the drying temperature of 80 to 120° C. and the drying time for 20 to 40 min.

Here, completion of the resulting object after the drying step can be a state that when the surface of the multi layered decorative copper-silver object is cut or polished so that the wood grain metal pattern appears, to form notches on the object, the resulting object may be preferably dried in degree of the condition that the object can be satisfactorily cut or polished. Preferably, the completion state means a condition that steam does not appear from the main body of the shaped object and the shaped copper-silver object, heated at 80 to 120° C. The steam emission, for example, can be detected by determining whether dew concentrates on a glass plate or a stainless steel plate when the main body of the shaped object or the multi layered copper-silver object, heated at 80 to 120° C., is placed close to the glass plate or the stainless steel plate. If the dew is not concentrated, the drying process may be regarded as completed.

Note the drying process may be conducted by natural drying, and in this case, drying for one day or more is particularly preferable. The completed drying state after heating by a dryer may be determined that dew is not concentrated as mentioned above.

[Wood Grain Metal Pattern Forming Step]

In the step, a surface of the dried multi layered decorative copper-silver object is cut or polished so that the wood grain metal pattern appears, to form the notches on the object.

Since the multi layered decorative copper-silver object is dried in the [Multi Layered Decorative Copper-Silver Object Drying Step], this method allows cutting ability of the decorative object to be improved, and the sharp notches and extremely fine notches to be formed very easily. Accordingly, this method allows a shaped object approaching to a decorative article produced by the wood grain metal technique of the traditional handcrafts to be formed. In contrast, the shaped object in the clay-like state before the drying process, can not be cut sharply, resulting in production of the object far from the decorative article produced by the wood grain metal technique.

Note: such a wood grain metal pattern forming step is not conducted at all in the Patent Document 5.

The wood grain metal pattern forming step corresponds to the operation of creating a wood grain like pattern by beating and cutting the object using a chisel, and flattening protrusion parts of the object by a hammer. Here, the operation of beating and cutting the object by a chisel and the operation of flattening the protrusion parts by a hammer are really dangerous and heavy labor, respectively. In contrast, the wood grain metal pattern forming step of the present invention comprises an easy operation of cutting or polishing the surface of the dried multi layered decorative copper-silver object by a file, a graver, and a sandblast so as to form the notches on the object. Therefore, the above mentioned step of the present invention needs little labor and can be very easily conducted.

[Sinter Producing Step]

In the step, a decorative object on which notches are formed is sintered to obtain a decorative object sinter. As mentioned hereinbefore, the sintering process of the decorative object on which notches are formed may be performed in the reduction atmosphere or in the air (or in the oxidation atmosphere).

When the decorative object is sintered in the air, the object is sintered at 660 to 770° C. for 3 to 40 min, and particularly preferably at 700 to 750° C. for 10 to 15 min. Note the above mentioned sintering process is conducted at a lower temperature and in a shorter time than the sintering process of the shaped object made from the plastic copper containing clay compound.

By the way, the conditions for sintering the shaped object made from only the plastic copper containing clay compound in the air include: at 990° C. for 3 to 6 min, at 980° C. for 4 to 15 min, at 970° C. for 5 to 30 min, at 950° C. for 5 to 40 min, at 850° C. for 10 to 50 min, and at 800° C. for 30 to 60 min as standard conditions, if the plastic copper containing clay compound of which component powder consists of pure copper. Preferably, the sintering temperature is at 850 to 980° C., and more preferably at 950 to 970° C.

Further, when the decorative object is sintered in the air, an electric furnace may be pre-heated at the above mentioned temperature, the decorative object may be put in the electric furnace of which the temperature is kept at the above mentioned temperature, then, the predetermined temperature may be maintained in the predetermined time, and finally the decorative object sinter may be taken out from the electric furnace, thereby to be rapidly cooled. In such a case, since the sintering process is not conducted in the reduction atmosphere as conducted in conventional techniques, this may avoid complicated procedures of continuously flowing the inert gas such as argon gas or nitrogen gas, and putting a reduction agent such as charcoal together with the shaped copper object in a sealed vessel so as to heat the mixture in the vessel from the outside. The above mentioned advantages allow the method for producing the decorative metallic article to be more easily applicable in a further education school or the like.

Furthermore, of course, it is needless to say that the shaped object can be sintered in the reduction atmosphere at the same temperature as mentioned above. In such a case, preferably, it is better to have the sintering temperature higher and the sintering time longer. Moreover, for example, the shaped object may be fired in the air to burn the organic binder at the first half stage, and then the sintering in the reduction atmosphere may be conducted at the latter half stage. In such a case, for example, when the temperature of the first half stage conducting the firing in the air reaches 350 to 450° C. from room temperature, the decorative object is immediately taken out from a heating source such as an electric furnace, the resulting object is put into a sealed stainless steel vessel together with a reduction agent such as charcoal. Then, the sealed vessel is put in the electric furnace to heat it from room temperature to 700 to 800° C. Subsequently, the temperature was kept for 30 min to 9 hr, allowing the decorative object to be sintered in the reduction atmosphere.

In the sintering process under the argon atmosphere, the sintering process is conducted by flowing argon gas in the electric furnace to prevent the air from entering the furnace.

[Surface Oxidation Film Removing Step]

In the step, an oxidation film on the surface of the decorative object sinter to be detached by rapid cooling, pickling and polishing treatments or the like.

The rapid cooling, pickling and polishing treatments are well known techniques as a sintering technique of this kind of the plastic precious metal containing composition. The pickling treatment is conducted by immersing the resulting sinter in a solution of a solid acid material for pickling, such as sodium hydrogen sulfate (a commercially available product) or dilute sulfuric acid for about 5 min. Then, depending on the necessity, the resulting sinter is polished by a brush and washed soon. In the polishing treatment, since a variety of polishing tools such as a polishing spatula, a thread buff, Leutor, a sponge polishing material, and a stainless-steel brush are commercially available, these tools are appropriately selected and used for polishing.

### EXAMPLE

### Example 1

### Production of Decorative Copper-Silver Metallic Article having Wood Grain Metal Pattern

<Materials Used>

A malleable copper clay compound containing pure copper powder, and prepared as a mixed copper powder by mixing a first copper powder with a mean particle diameter of 2.5 μm in 50 wt % (or 45 wt % of the total material weight) and a second copper powder with a mean particle diameter of 10 μm in 50 wt % (or 45 wt % of the total material weight). Then, the mixed copper powder in 90 wt %, methylcellulose in 1.20 wt % and sodium carboxymethylcellulose in 0.30 wt % as organic binders, and water in 8.50 wt % were sufficiently mixed to produce a plastic copper containing clay compound.

A malleable silver clay compound containing pure silver, and prepared as a mixed silver powder by mixing a first silver powder with a mean particle diameter of 2.5 μm in 50 wt % (or 46 wt % of the total material weight) and a second silver powder with a mean particle diameter of 20 μm in 50 wt % (or 46 wt % of the total material weight). Then, the mixed silver powder in 92 wt %, cellulose in 0.8 wt % and starch in 0.7 wt % as organic binders, and water as the remainder thereby to form a water soluble binder, were sufficiently mixed to produce a plastic silver containing clay compound.

<Plate Forming Step>

In this step, were used the plastic copper containing clay compound and the plastic silver containing clay compound.

First, the plastic copper containing clay compound was spread flatly with a thickness of 2 mm by a roller, to produce a copper plate 61 shown in FIG. 1.

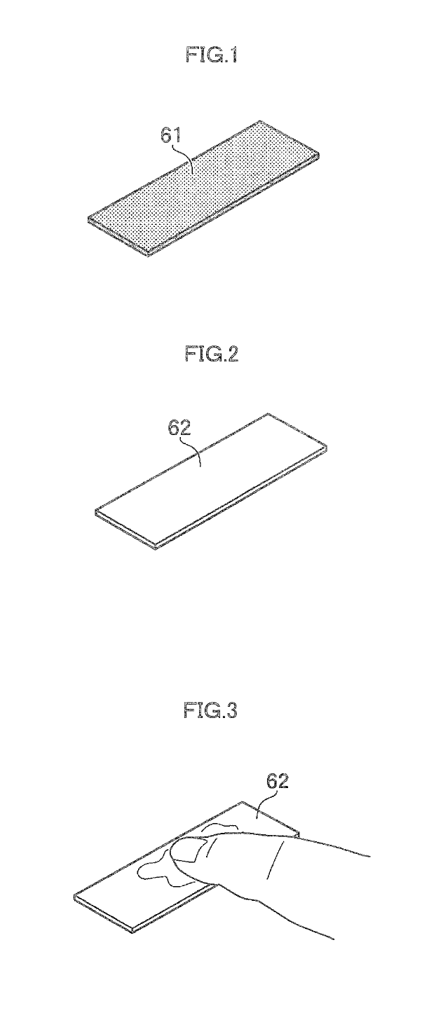

Similarly, the plastic silver containing clay compound was spread flatly with a thickness of 2 mm by a roller, to produce a silver plate 62 shown in FIG. 2.

<Multi Layering and Adhesion Step>

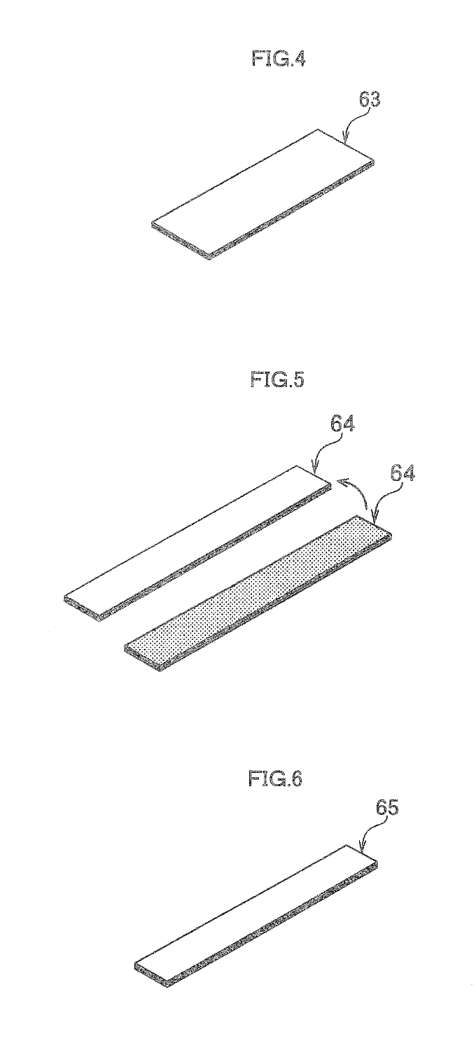

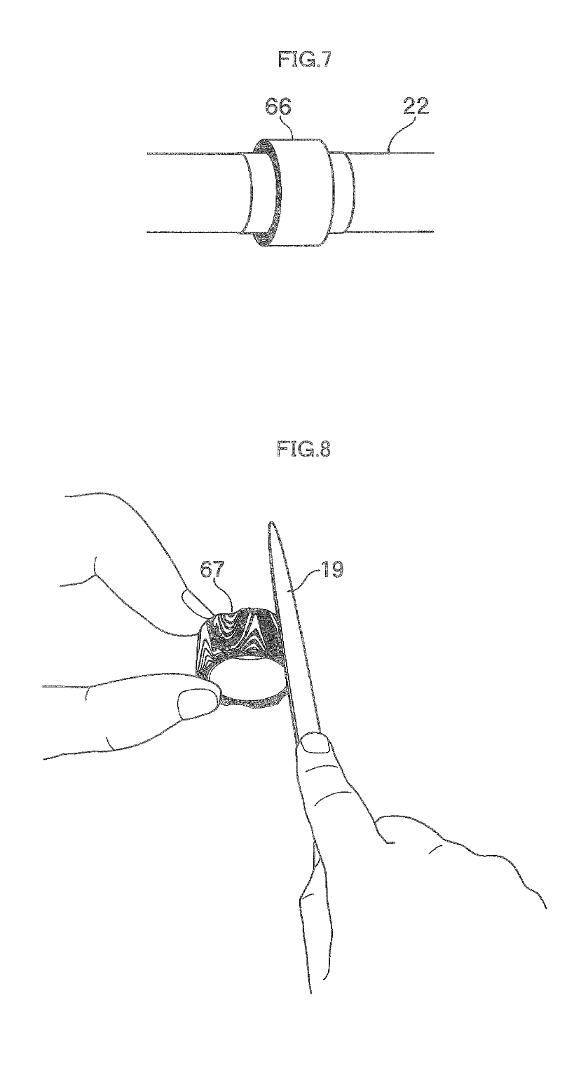

When the copper plate 61 and the silver plate 62 are laminated to be joined together as shown in FIG. 3, water was applied to the joint surfaces of both plates for laminating the plates (with a laminated thickness of about 4 mm). Then, the laminated plates were spread flatly by a roller until the thickness became about 3 mm, thereby to produce a composite plate 63 shown in FIG. 4.

The elongated composite plate 63 was halved as shown in FIG. 5. When the halved composite plates 64 were laminated to be joined together, similarly to the above mentioned method, a small amount of water was applied to the join surfaces, and a layer of the copper plate 61 and a layer of the silver plate 62 were mutually laminated one another (with the laminated thickness of about 6 mm). In that state, the composite plate 65 was spread flatly by a roller until the thickness became about 3 mm.

Such an operation was repeated for three times, to obtain a multi layered plate 65 in which the layer of the copper plate 61 and the layer of the silver plate 62 were mutually laminated one another.

<Decorative Object Forming Step>

A surplus part of the multi layered plate 65 that was spread so that the thickness finally became about 3 mm in the previous step, was cut off by a cutter, and then the multi layered plate was rolled up to a wood shaft 22 to shape a ring-like multi layered copper-silver decorative object 66.

<Multi Layered Copper-Silver Decorative Object Drying Step>

The resulting ring-like multi layered copper-silver decorative object 66 was put in a drying machine set at the drying temperature of 100° C., and in the drying time for 30 min, to dry the decorative object 66.

<Wood Grain Metal Pattern Forming Step>

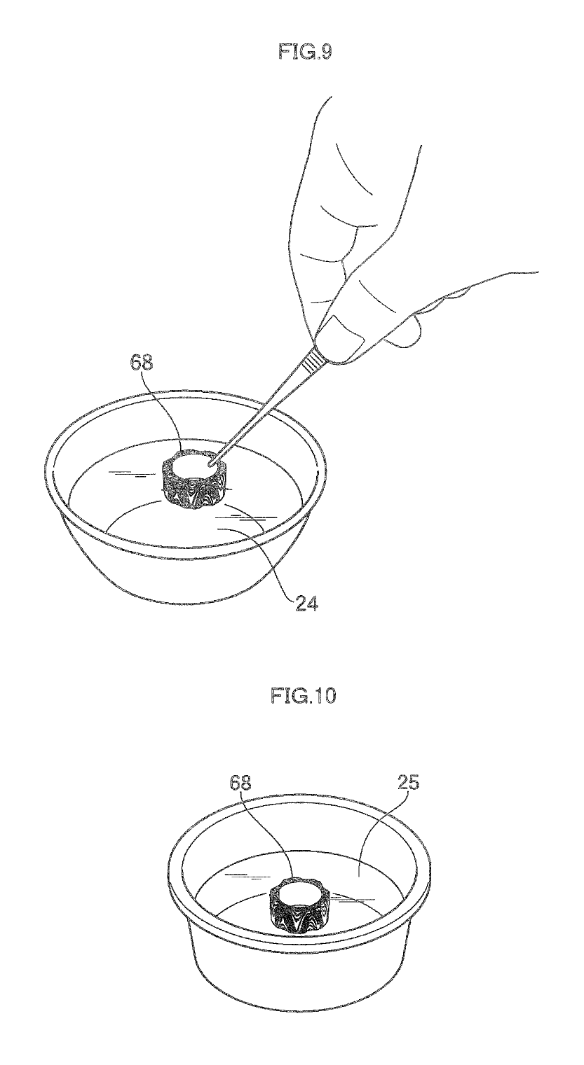

A surface of a part of the dried multi layered copper-silver decorative object was slantingly scraped by a second-cut file so that a wood grain metal pattern appears as shown in FIG. 8, thereby to form notches. Then, the whole body of the resulting object was treated to be adjusted using a sponge polishing material (trade name: 3M™ sponge polishing material, Sumitomo 3M Ltd., Type: super fine #320-#600), whereby a decorative object 67 forming the notches thereon was obtained.

<Sinter Producing Step>

The obtained decorative object 67 forming the notches thereon was sintered at 750° C. for 10 min.

Note the air sintering process was performed by pre-heating the electric furnace at the above mentioned temperature, putting the resulting object in the electric furnace of which temperature was kept at the above mentioned temperature, and keeping the predetermined temperature and time.

<Surface Oxidation Film Removing Step>

After the sintering process, a sinter 68 was put into water 24 to be rapidly cooled. Accordingly, the oxidation film was well detached.

Next, as shown in FIG. 10, the sinter 68 was immersed in a solution 25 of a solid acidic material for pickling (trade name: Pickling Compound, GROBET FULE CO. OF AMERICA INC.), thereby to remove the oxidation film on the surface of the sinter 68.

The surface of the sinter was polished by a stainless-steel brush or the like where necessary, to thereby bring about a metallic luster.

Accordingly, as shown in FIG. 11, the above mentioned method allows a decorative metallic article (or ring) 69 having a wood grain metal pattern created by integrating the two kinds (or colors) of metals such as silver and copper as shown in FIG. 11, which requires high degree of difficult technique among chasing techniques, to be very easily obtained. The obtained decorative metallic article (or ring) 69 was shown in FIG. 12 as a photograph substituting the diagram.

### Example 2

### Evaluation of Air Sintering Conditions of Copper-Silver Sinter

Next, a pre-test piece having a length of 60 mm, a width of 12 mm and a thickness of 2.5 mm was produced, by following the materials and each step in the [Production of Decorative Copper-Silver Metallic Article having Wood Grain Metal Pattern].

The obtained pre-test piece was dried at 100° C. for 30 min, and subsequently sintered in the air at 650° C. for 30 min to at 850° C. for 5 min. Herein, note the higher the sintering temperature was set, the shorter the sintering time was adjusted. Then, each of the pre-test pieces was put in the electric furnace kept at the respective predetermined temperatures, by changing the sintering conditions from Test 1 to Test 6, respectively. Further, after rising the sintering temperatures again to the predetermined temperatures, the pre-test pieces were sintered for the predetermined periods respectively, and then put into water to be rapidly cooled, whereby sintered test pieces were obtained.

Note the evaluation column in Table 1 shows the total evaluation result of each test piece based on the visual observation result of the appearance thereof, and the result whether the polishing thereof was performed without any defect. In the table, “Good” means an evaluation that the test piece is usable and has sufficient strength for use, while “Poor” means an evaluation determined that the surface of the test piece is uneven or the strength thereof in the polishing treatment or the like is insufficient.

<Results>

TABLE 1

| | Sintering Conditions | Evaluation |
|---|---|---|
| Test 1 | 650° C. × 30 min | Poor |
| Test 2 | 700° C. × 15 min | Good |
| Test 3 | 750° C. × 10 min | Good |
| Test 4 | 780° C. × 5 min | Poor |
| Test 5 | 800° C. × 5 min | Poor |
| Test 6 | 850° C. × 5 min | Poor |

<Discussion>

As mentioned above, good results were not obtained in Tests 4 to 6. In contrast, good results were obtained in Tests 2 and 3. Accordingly, it was determined that the sintering conditions: at 700° C. for 15 min to at 750° C. for 10 min, were preferable to perform a good air sintering of the mixed copper-silver shaped object.

### Example 3

### Production of Decorative Copper-Silver Metallic Article having Wood Grain Metal Pattern

A mixed copper powder in 90 wt % [composition of the mixed powder by weight: a copper powder (made of pure copper) in 47.5 wt % with a mean particle diameter of 2.5 μm and another copper powder (made of pure copper) in 47.5 wt % with a mean particle diameter of 10 μm, and zirconium oxide in 5.0 wt %], and as organic binders, methylcellulose in 1.20 wt % and hydroxypropylmethylcellulose in 0.15 wt %, starch in 0.8 wt %, lignin in 0.10 wt %, and water in 7.75 wt %, were sufficiently mixed to prepare a plastic copper containing clay compound.

In the meantime, a plastic silver containing clay compound was prepared as in the completely same method of aforementioned Example 1, by sufficiently mixing a mixed silver powder in 92 wt % [composition of the mixed powder by weight: a first silver powder (made of pure silver) in 50 wt % with a mean particle diameter of 2.5 μm and a second silver powder (made of pure silver) in 50 wt % with a mean particle diameter of 20 μm], and a water-soluble binder including starch in 0.7 wt %, cellulose in 0.80 wt % as organic binders, and the remainder of water.

Those resulting clay compounds were treated in the <Plate Forming Step> and <Multi layering and Adhesion Step> as similarly to Example 1. After the treatments, the next steps were conducted.

<Decorative Object Forming Step>

A peripheral part of the multi layered plate with a final thickness of 5 mm was cut off by a cutter in the previous step, to forma disk-like object. Further, one circle part was formed inside of the disk-like object, by cutting off the part as forming a pattern-like shape, using a chisel or a cutter.

<Multi Layered Decorative Copper-Silver Object Drying Step>

A masking sheet made of a vinyl based resin in which a pattern was cut (trade name: Stencil Sheet) was pasted on the upper surface of the resulting dried disk-like multi layered decorative copper-silver object, thereby to conduct a masking treatment. Then, the masking treated object was cut or polished by a sandblast at the regions corresponding to the areas which were not masked through the cutting pattern on the masking sheet, thereby to dig through in the thickness direction of the disk-like multi layered decorative copper-silver object so that the wood grain metal pattern appeared on the multi layered decorative copper-silver object.

<Sinter Producing Step>

The decorative object thus obtained on which the notches were formed, was put in an electric furnace to place it on a board made of fire resistance ceramic fibers (trade name: Kaowool Board). Then, when the temperature inside the furnace reached 450° C. from room temperature in the air (that is, firing in the air), the decorative object was immediately taken out from the electric furnace.

After that, charcoal was put in a stainless steel vessel to form a bed thereof, and the air sintered decorative object was embedded under the upper surface of the charcoal at a position in a depth of about 1 cm. Then, the stainless steel vessel was sealed. Next, the stainless steel vessel was put in the electric furnace, heated until the temperature inside the furnace reached 780° C. from room temperature, and the temperature was kept for 8 hr (that is, sintering in the reduction atmosphere). After 8 hr, a sinter was taken out from the furnace, and cooled in the air.

<Surface Oxidation Film Removing Step>

Here, the resulting sinter needed no polishing treatment. Where necessary, the surface of the sinter was polished by a stainless steel brush or the like.

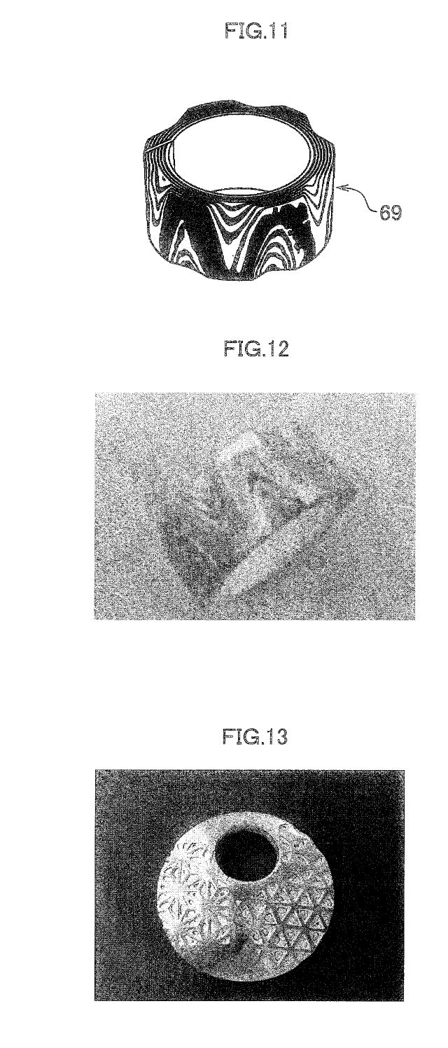

Accordingly, the above mentioned method allows a decorative metallic article (or pendant) having a wood grain metal pattern created by integrating the two kinds (or colors) of metals such as silver and copper, which requires high degree of difficult skill among chasing techniques, to be very easily obtained. The decorative metallic article (or pendant) thus obtained is shown in FIG. 13 as a photograph substituting the diagram.

### DESCRIPTION OF REFERENCE NUMERALS

69 Decorative metallic article (or ring) having wood grain metal pattern

1. A method for producing a decorative metallic article having a wood grain metal pattern comprising:
a plate forming step of forming a plastic copper containing clay compound including an organic binder and at least one kind of a powder metal selected from copper and a copper alloy, and a plastic silver containing clay compound including an organic binder and at least one kind of a powder metal selected from silver and a silver alloy, into plate-like shapes respectively, thereby to produce a copper plate and a silver plate;
a multi layering and adhesion step of applying water to joint surfaces of the copper plate and the silver plate, to mutually laminate the plates one another, and adding a lord on a laminate to elongate the laminate so that a thickness of the laminated plates decreases in 10% or more, thereby to adhesively paste the laminated plates together;
a decorative object forming step of forming a multi layered decorative copper-silver object by using a multi layered plate produced after conducting the multi layering and adhesion step;
a multi layered decorative copper-silver object drying step of drying the multi layered decorative copper-silver object;
a wood grain metal pattern forming step of cutting or polishing a surface of the dried multi layered decorative copper-silver object so that the wood grain metal pattern appears on the object, thereby to form notches; and
a sinter producing step of sintering the decorative object on which the notches are formed so as to obtain a decorative object sinter.

2. The method for producing a decorative metallic article having a wood grain metal pattern as described in claim 1, the multi layering and adhesion step comprising the processes of:
applying water to joint surfaces of the copper plate and the silver plate, to mutually laminate the plates one another,
adding a lord on a laminate to elongate the laminate so that a thickness of the laminated plates decreases in 10% or more, thereby to adhesively paste the laminated plates together for forming a copper-silver plate;
further cutting or folding back the copper-silver plate;
applying water to joint surfaces of the resulting copper-silver plate to mutually laminate the plates one another;
adding a lord on a laminate to elongate the laminate so that a thickness of the laminated plates decreases in 10% or more, thereby to adhesively paste the laminated plates together for obtaining a multi layered copper-silver plate;
repeating the above mentioned processes at least one time for obtaining the multi layered copper-silver plate.

3. The method for producing a decorative metallic article having a wood grain metal pattern as described in claim 1 or claim 2, the multi layering and adhesion step comprising a process of elongating the laminated plates so that a thickness of the laminated plates decreases in 20 to 80% so as to adhesively paste the laminated plates together.

4. The method for producing a decorative metallic article having a wood grain metal pattern as described in claim 1 or claim 2,
the decorative object forming step comprising a process of forming a multi layered copper-silver ring by shaping the multi layered plate produced after conducting the multi layering and adhesion step, into a ring-like object; and
the wood grain metal pattern forming step comprising processes of: cutting slantingly both circular peripheries of the dried multi layered copper-silver ring with alternating the left and right side peripheries so that the wood grain metal pattern appears, thereby to form the notches at both circular peripheries of the ring, mutually in the left and right side peripheries each other.

5. The method for producing a decorative metallic article having a wood grain metal pattern as described in claim 1 or claim 2,
the decorative object forming step comprising a process of cutting at least an outer circumference of the multi layered plate produced after conducting the multi layering and adhesion step, thereby to form the multi layered decorative copper-silver object; and
the wood grain metal pattern forming step comprising processes of masking the surface of the dried copper-multi layered decorative object by the masking sheet cut off to fit the predetermined pattern, and forming the notches by cutting or polishing the surface of the dried multi layered decorative copper-silver object by a sandblast, so that the wood grain metal pattern appears to fit the cut off pattern of the masking sheet.

6. The method for producing a decorative metallic article having a wood grain metal pattern as described in claim 1 or claim 2, the multi layered decorative copper-silver object being dried by natural drying or heat drying at a drying temperature of 80 to 180° C. and in a drying time for 10 to 60 min.

7. The method for producing a decorative metallic article having a wood grain metal pattern as described in claim 1 or claim 2, the sinter producing step being conducted in the air.

8. The method for producing a decorative metallic article having a wood grain metal pattern as described in claim 7, the sinter producing step being conducted at a sintering temperature of 660 to 770° C. and in a drying time for 3 to 40 min.

9. The method for producing a decorative metallic article having a wood grain metal pattern as described in claim 8,
at least one kind of the powder metal selected from copper and a copper alloy included in the plastic copper containing clay compound being a mixed copper powder consisting of a first powder with a mean particle diameter of 0.1 to 4.0 μm in 25 to 75 wt %, and the remainder of a second powder with a mean particle diameter in the range from more than 4.0 μm to 10 μm or less; and
at least one kind of the powder metal selected from silver and a silver alloy included in the plastic silver containing clay compound being a mixed silver powder consisting of a first powder with a mean particle diameter of 0.1 to 4.0 μm in 25 to 75 wt %, and the remainder of a second powder with a mean particle diameter in the range from more than 4.0 μm to 40 μm or less.

10. A decorative metallic article having a wood grain metal pattern, the decorative metallic article being produced by the method as described in claim 1 or claim 2.
